(19) United States
(12) Patent Application Publication
(10) Pub. No.: US 2009/0290139 A1
(43) Pub. Date: Nov. 26, 2009

(54) SUBSTRATE TABLE, SENSOR AND METHOD

(75) Inventors: Arie Johan VAN DER SIJS, Veldhoven (NL); Willem Jurrianus Venema, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/470,099

(22) Filed: May 21, 2009

Related U.S. Application Data
(60) Provisional application No. 61/071,851, filed on May 21, 2008.

(51) Int. Cl. G03B 27/58; G01J 1/44

(52) U.S. Cl. 355/72; 250/206

(57) ABSTRACT

A sensor for measuring a patterned beam of radiation in a lithographic exposure apparatus includes a receiving part for receiving the patterned beam of radiation and a processing part arranged to receive at least a part of the patterned radiation beam via the receiving part. The receiving part of the sensor is integrated in a substrate table for holding a substrate.

This application claims priority and benefit under 35 U.S.C. §119(e) to U.S. Provisional Patent Application No. 61/071,851, entitled “Substrate Table, Sensor and Method,” filed on May 21, 2008. The contents of that application are incorporated herein in their entirety by reference.

### FIELD

The present invention relates to a substrate table for holding a substrate in a lithographic exposure apparatus for exposing a substrate to a patterned radiation beam. The invention also relates to a sensor for measuring a patterned beam of radiation in a lithographic exposure apparatus. Furthermore, the invention relates to a method of positioning a target portion of a substrate in a patterned beam of radiation.

### BACKGROUND

A lithographic exposure apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). The lithographic exposure apparatus comprises a substrate stage which in turn comprises a mirror block wherein a plurality of sensors is arranged, for instance for determining the position, and a substrate table on which the substrate is placed.

Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to accurately apply a desired pattern onto a target portion of a substrate, the reticle should be aligned with respect to the substrate. Therefore, according to the prior art, the relative position of the reticle with respect to the substrate is set accurately, by measuring and adjusting the relative position. Alignment of the patterning device with respect to the substrate may, according to the state of the art, be done using two alignment actions.

In the first action the substrate is aligned with respect to the substrate stage carrying the substrate, while in the second action the reticle is aligned with respect to the substrate stage. As a result of these two actions, the reticle is aligned with respect to the substrate, as desired.

In case a single stage machine is used, the first and second actions are carried out at the exposure position. In case a dual stage machine is used, the first action may be carried out at a first position, remote from the exposure position. Then, the substrate stage with the substrate positioned on it is transported to the second, exposure position, where the second action is performed.

The first action may be carried out with two sensor assemblies. A first sensor assembly comprises an alignment sensor and measures the relative position of the substrate with respect to the substrate stage in X, Y and Rz directions, where the XY plane is defined as the plane that is substantially parallel with the surface of the substrate, the X- and Y-direction being substantially perpendicular with respect to each other. The Z-direction is substantially perpendicular with respect to the X- and Y-directions, so Rz represents a rotation in the XY plane, about the Z-direction. A more detailed description about this sensor is for instance provided in U.S. Pat. No. 6,297,876. A second sensor assembly, usually referred to as the level sensor, measures the height of the substrate surface in dependence on locations on the substrate to be exposed, creating a height map based on the determined heights, and also determines the rotations about the X and Y axes: Rx, Ry.

Next, in the second action, the reticle is aligned with respect to the substrate stage. This may be done with an image sensor, such as a transmission image sensor, as will be known to a person skilled in the art. A transmission image sensor measurement is performed by imaging a first alignment pattern (mask alignment mark) provided on the reticle or on the reticle stage carrying the reticle through the projection system (lens) onto one or more plates (i.e. the transmission image sensor plate) provided at or in the substrate stage. The transmission image sensor plate comprises a second alignment pattern. The alignment patterns may include a number of isolated lines. Inside the substrate stage, behind the second alignment pattern in the transmission image sensor plate, a light sensitive detector is provided, e.g. a diode, that measures the light intensity of the imaged first alignment pattern. When the projected image (i.e. the aerial image) of the first alignment pattern exactly matches the second alignment pattern, the sensor measures a maximum intensity. The substrate stage is now moved in the X- and Y-directions on different Z-levels, while the sensor measures the intensity. Therefore, the transmission image sensor is actually an aerial image sensor, in which multiple scanning slits probe the aerial image of isolated lines. Based on these measurements, an optimal relative position of the substrate stage can be determined. A typical Transmission image sensor will be explained in further detail below with reference to FIGS. 2 and 3.

As mentioned above, in the first action, the alignment sensor measures the position of the substrate with respect to the substrate stage carrying the substrate. The alignment sensor also measures the XY position of the transmission image sensor plate, more specifically the position of a fiducial mark on the transmission image sensor plate, while the level sensor, in combination with a further sensor (Z-interferometer), measures the Z-position thereof. Based on the position of the substrate with respect to the substrate stage and the position of the transmission image sensor with respect to the substrate stage, the position of the substrate relative to the transmission image sensor can be determined.

As mentioned above as well, in the second action the reticle is aligned with respect to the substrate stage. The position of the aerial image may be measured by the Transmission image sensor and this gives the position of the aerial image with respect to the Transmission image sensor. The information from both actions may be combined to calculate the optimal position of the substrate stage (and possibly to determine the lens corrections as well) for the best match of the aerial image and the substrate.

Both the transmission image sensor position as measured with the alignment sensor and the position of the aerial image with respect to the transmission image sensor are determined by lithographically applied structures (“gratings”) on the (quartz) top plates of the transmission image sensor. These lithographic applied structures on the transmission image sensor plate(s) are arranged in the mirror block of the substrate stage, while the substrate itself is placed on the substrate table, which is another part of the substrate stage.

Due to the fact that the transmission image sensor (and possibly also one or more other sensors) are located on the mirror block of the substrate stage while the substrate resides on the substrate table, the arrangement is sensitive to any displacements of the substrate relative to the mirror block. The displacement may be induced by the accelerations during substrate stage movements and swaps. They may also be caused by the difference in thermal expansion of different elements of the substrate stage. Similarly, any instabilities in the mounting of the sensors (e.g. “First Scan Effect”, transmission image sensor plate slip) may affect the outcome of the measurements, since the mountings are directly connected with the gratings.

### SUMMARY

It is desirable to provide a sensor for measuring a patterned beam of radiation in a lithographic exposure apparatus which is more accurate.

According to an embodiment of the invention there is provided a substrate table for holding a substrate in a lithographic exposure apparatus for exposing a substrate to a patterned radiation beam wherein an optical part of a sensor is integrated with the substrate table, the optical part of the sensor being arranged to receive the patterned radiation beam, to determine properties of the patterned radiation beam depending on the relative positions of the optical part and the patterned radiation beam and arranged to cooperate with a further part of the sensor arranged to receive at least a part of the patterned radiation beam via the optical part.

According to a further embodiment of the invention there is provided a sensor for measuring a patterned beam of radiation in a lithographic exposure apparatus, comprising a receiving part for receiving the patterned beam of radiation and a processing part arranged to receive at least a part of the patterned radiation beam via the receiving part, characterized in that the receiving part being integrated in a substrate table for holding a substrate.

A method of positioning a target portion of a substrate in a patterned beam of radiation according to an embodiment of the invention comprises:

positioning the substrate on a substrate table;

determining the position of the target portion by measuring the position of a plurality of alignment marks on the substrate using an alignment sensor;

determining the position of a radiation sensor using the alignment sensor;

measuring the position of the patterned beam of radiation relative to a receiving part of a sensor integrated on the substrate table.

using the determined position of the target portion, the determined position of the radiation sensor and the determined position of the patterned beam of radiation to position the target portion in the patterned beam of radiation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a side view in perspective of a prior art substrate stage chuck;

FIG. 3 depicts a cross-section of a part of the reticle stage and the substrate stage chuck depicted in FIG. 2;

FIG. 4 depicts a side view of a substrate stage chuck according to an embodiment of the present invention; and

FIG. 5 depicts a cross-section of the embodiment of FIG. 4.

### DETAILED DESCRIPTION

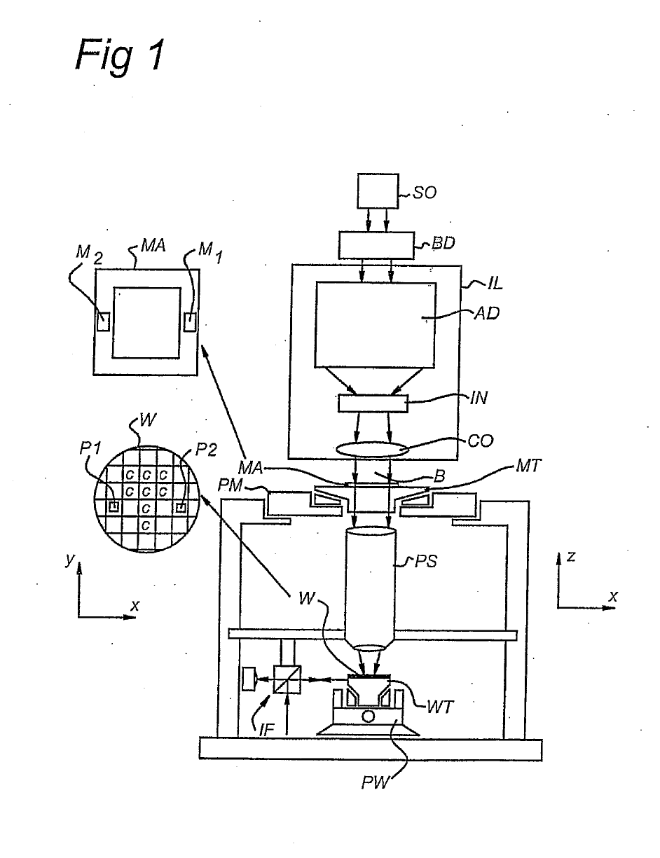

FIG. 1 schematically depicts a lithographic apparatus according to one embodiment of the invention. The apparatus comprises:

an illumination system (illuminator) IL configured to condition a radiation beam B (e.g. UV radiation or EUV radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An example of an immersion type lithographic apparatus is disclosed in U.S. Pat. No. 4,509,852, hereby incorporated in its entirety by reference. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device as part of an interferometry position measurement system to be described hereafter, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

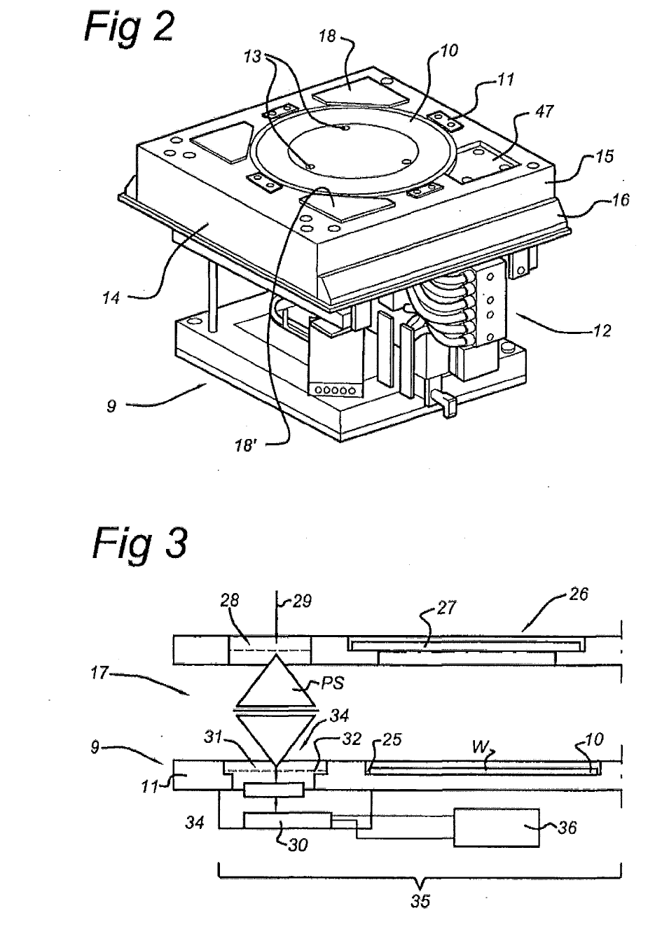

FIGS. 2 and 3 show an example of an existing substrate stage 9 in more detail. The substrate stage 9 comprises a substrate table 10 and a second positioner which in turn comprises a support element 11, a substrate stage carrier module 12 and a number of positioning motors for positioning the support element 11 (and the substrate table 10 attached to it) relative to the substrate stage carrier module 12. In the embodiment the support element 11 is a mirror block provided with a plurality of mirrors that may be used to position the mirror block and the substrate table 10 provided thereon.

The substrate table 10 is configured to clamp a substrate (not shown in FIG. 2), for example, by vacuum. Furthermore, the substrate table 10 has three movable pins guided in holes 13 (FIG. 2). The pins are used to load or unload the substrate (W) onto or from the substrate table 10. To this end the pins may be raised above the substrate table 10 to accept or release the substrate. The substrate table 10 is placed on top of the upper surface of the mirror block 11, more specifically on the upper surface of a recess 25 (cf. FIG. 3) formed in the mirror block 11. In an embodiment of the invention the mirror block 11 and the substrate table 10 are separate elements, one placed on top of the other.

In an embodiment also the substrate table 10 is clamped to the mirror block 11, for example, by vacuum. In this embodiment the substrate table is made of wear-resistant material (for instance silicium carbide), is polished extremely flat, and contains a complicated structure (pimples) to support the substrate at specific points. The substrate (W) itself is clamped again by vacuum to the substrate table 10. In this embodiment the substrate table provides a specific mechanical interface between mirror block 11 and substrate (W).

The mirror block 11 not only supports the substrate table 10, but is also part of the interferometer position measurement system. The mirrors of the mirror block, for instance mirror planes 14-16, reflect the interferometer laser beams to the interferometers (IF). The mirror block 11 is supported in turn by the substrate stage carrier module 12 using the earlier-mentioned positioning motors.

A number of sensors are used at substrate level for evaluating and optimizing imaging performance. These may include transmission image sensors, spot sensors for measuring exposure radiation dose and integrated lens interferometers at scanner (ILIAS) sensors. Examples of such transmission image sensor and ILIAS sensors are described below in more detail.

The lithographic apparatus may be provided with a transmission image sensor module 17 including one or more transmission image sensors 18,18′ located at the substrate level. Typically the lithographic apparatus is provided with two Transmission image sensors 18,18′, located at two opposite corners of the substrate table 10. As mentioned earlier, the Transmission image sensors 18,18′ are used for aligning reticle stage 26 and substrate stage 9 relative to each other and for measuring the quality of the projected image.

Referring to FIG. 3, the reticle 27 or the reticle stage 26 may comprise one or more reticle gratings or reticle marks 28 (cf. M1,M2 in FIG. 1). An image of the reticle mark 28 is formed by the projection system PS onto a plate 32 of the transmission image sensor 18,18′, the image being formed by a radiation beam 29. The plate 32 of the sensor 18,18′ is arranged in the mirror block 11 and comprises a grating structure 31 with transmissive and reflective (or absorbing) elements (for instance a transmissive pattern in a layer of chromium). When the image is in focus at, and aligned with the grating structure 31 of the transmission image sensor plate 32, the transmissive elements correspond to the image. A detector 30 (such as a photodiode) is positioned behind the grating structure 31. The detector 30 is arranged and constructed to measure the intensity of the radiation behind the grating structure.

If the image is in focus at, and aligned with the structure, all radiation passes through the structure, resulting in a maximal intensity at the detector. If the image is not in focus at the grating structure 31 or is misaligned with the structure, part of the radiation falls onto the reflective (or absorbing) elements and the intensity measured by the detector 30 behind the structure will be lower.

At several relative positions between the reticle and the substrate stage intensities of radiation that has passed the reticle mark 28 and the grating structure 31 are measured by the detector 30 to find the position where the measured intensity has a maximum. This relative position corresponds with the reticle mark being in focus at and aligned with the structure of the Transmission image sensor 18,18′.

The Transmission image sensors 18 of a transmission image sensor module 17 each comprise an optical part 34 (i.e. the plate 32 including the grating 31) and an electro-optical part 35 (i.e. the photo detector 30 to measure the amount and distribution of the light that results from the interaction between the aerial image and the grating 31 and the electric circuits 36 associated with the photo detector 30). The accuracy of the sensor 18,18′ is primarily determined by the optical part 34 (position of gratings etc.). Currently, the optical and electro-optical part of the sensors are all integrated in the mirror block 11, i.e. on the second positioner, as is shown in FIG. 3. As the transmission image sensor is integrated in the mirror block 11 of the substrate stage 9 and the substrate (W) resides on the substrate table 10, they are sensitive to any displacements of the substrate table relative to the mirror block, for instance displacements caused by thermal expansion and/or by movement of the mirror block.

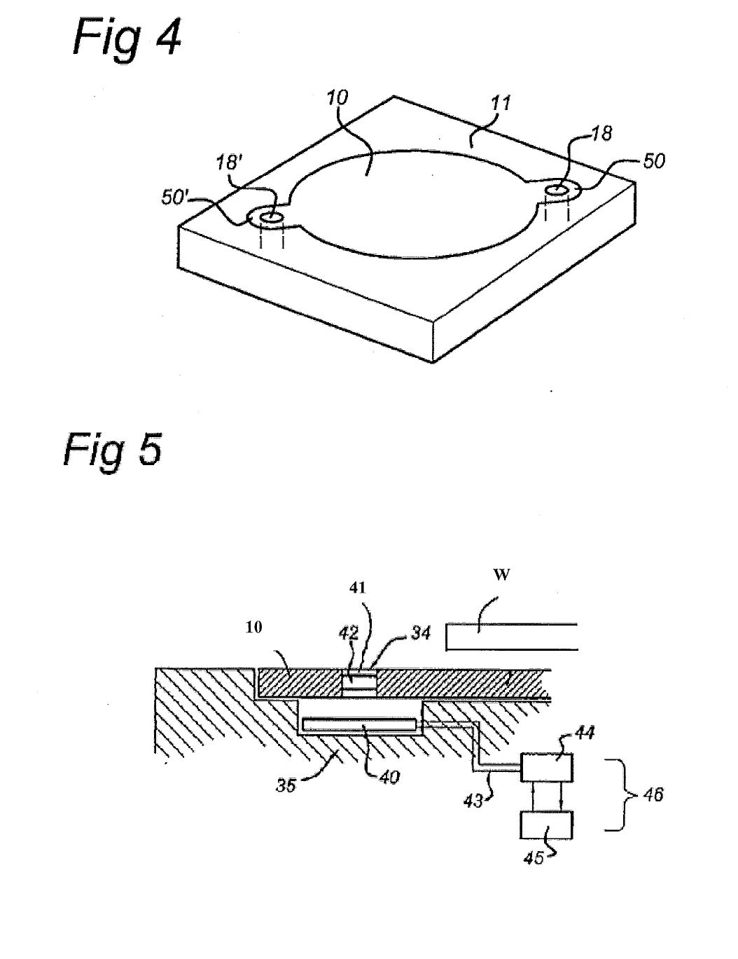

FIGS. 4 and 5 depict an embodiment of the present invention. FIG. 4 depicts a substrate table 10 and a mirror block 11 of the second positioner. In the present embodiment at least a part of the at least one transmission image sensor 18,18′ is integrated with the substrate table 10 instead of in the mirror block 11. In embodiments of the invention the substrate table 10 comprises a generally circular plate on top of which a substrate can be placed, the plate also comprising one or more protruding plate portions for accommodating the sensor. Other shapes of the substrate table are also possible. More generally the substrate table comprises a central table portion configured to receive a substrate and at least one peripheral table portion extending radially from the central table portion, the peripheral table portion being arranged and constructed to receive at least a part of a sensor. When the apparatus comprises two or more sensors, the table may have a first peripheral portion and a second, opposite peripheral portion for accommodating a first and second sensor respectively.

In the embodiment shown in FIGS. 4 and 5, a light sensitive detector 40, such as a diode, is arranged behind a sensor grating 41 on the sensor plate 42. The detector 40 may be provided with cabling 43 for communicating the measured data to electronic circuitry 46, for instance a processor 44 and a memory device 45. The optical part 34 of the sensor (for instance the sensor plate 42 including the sensor grating 41) is arranged to function as a receiving part for receiving the patterned beam of radiation. The optical part for a large portion determines the accuracy of the measurements to be performed by the transmission image sensor module 17. The optical part 34 is arranged in the substrate table 10, while the remaining part of the sensor, i.e. the electro-optical part 35 (for instance, the light detector 40 and the electronic circuits 46) remains seated in the mirror block 11.

More specifically, in embodiments of the invention the transmission image sensor plate 42 is arranged in a local extension 50,50′ of the substrate table 10. In other embodiments, however, the entire substrate table is made larger so that a sufficient area is free to accommodate the sensors.

The alignment measurement is carried out by providing an alignment beam 29 to the mask alignment marker 28 and imaging the mask alignment marker 28 via the lens system PS on the sensor grating 41 on the sensor plate 42. The alignment beam 29 preferably originates from the same radiation source as used for exposing the substrate W (not shown in FIG. 4. The substrate table alignment marker 41 is of a transmissive type and both markers 28 and 41 have a predetermined corresponding pattern such that the pattern of the mask alignment marker 28 as projected on the substrate table alignment marker 41 by the lens system PS and the pattern of the substrate table alignment mark 41 are matching. This means that a maximum amount of light is transmitted through the substrate table alignment marker 21 if the relative positioning of the reticle MA and the substrate table 10 are correct. In that case, the detector 40 will sense a maximum amount of light.

In use the positions of alignment marks on the substrate W are determined with an alignment sensor at a measurement station of the lithographic exposure apparatus in a coordinate system of the second positioner. These positions are used to determine the positions of target areas on the substrate W.

Also the position of the sensor grating 41 is determined at the measurement station. The position of the sensor grating 41 is determined by measuring the position of a sensor alignment grating with the alignment sensor. The relative positions of the sensor grating 41 and the sensor alignment grating are very accurately determined previously. The position of the sensor grating is then determined by combining the measured position of the sensor alignment grating and the relative positions of the sensor grating 41 and the sensor alignment grating. Since the position of the sensor alignment grating was measured using the alignment sensor which was also use to measure the positions of the alignment marks on the substrate, the position of the sensor grating 41 is known in the same coordinate system as the positions of the target areas, i.e. the relative positions are known.

The second positioner is then moved to an exposure station in the lithographic exposure apparatus and the sensor is used to determine the position of an aerial image to which the substrate is to be exposed with the sensor grating 41. Since the relative positions of the sensor grating 41 and the target areas are known, the position of the aerial image is now linked to the positions of the target areas on the substrate W. Then the second positioner is used to position the target areas one by one in the aerial image for exposure.

The position of the aerial image is determined by moving the substrate table mirror block 11 (and therefore also the substrate table 10 attached thereto) in all three directions (X, Y, Z), for instance by making a scanning movement in the X- and Y-directions and performing these scans at different positions in the Z-direction, while constantly measuring the light intensity as received by the detector 40. The movements of the mirror block 11 are performed with second positioning device PW including the positioning motors as described with reference to FIG. 1. The position of the mirror block 11 and substrate table 10 where the detector 40 measures the maximum amount of light is considered to be the optimum relative position of the mirror block 11 and substrate table 10 with respect to the reticle 27.

One of the merits of embodiments of the invention is that the relation between substrate (wafer) and the sensor grating 41 (for instance the transmission image sensor grating 41 and/or an ILIAS grating), is not sensitive anymore to displacements (which may be mechanical or thermal in nature) of the substrate table 10 with respect to the mirror block 10. This is because the sensor grating is integrated on the substrate table and the substrate (wafer) is tightly clamped to the substrate table. This has a positive effect on the accuracy and robustness of the measurement process and, as a consequence, on the subsequent exposure process of the substrate as well.

Other advantages may be that since the sensor top surfaces, that is the sensor plates 42, are integral part of the wafer table, no separate stickering of sensors on immersion type lithographic apparatus is needed, and effects caused by the Immersion Hood (IH) crossing borders between the substrate table and mirror block and between the mirror block and the sensors are avoided or at least reduced. In some embodiment it may even be possible to avoid any crossing of the by the immersion hood during lot production. Furthermore, the size of the substrate table 10 may be extended to an even larger area of the mirror block 11 top surface, which may be advantageous from a flatness and manufacturability point of view. Another advantage is that thermal expansion is better controllable in the integrated case than in the case of independent substrate table and sensor expansions from fixed positions in the mirror block 11.

In embodiments of the invention the one or more local extensions may be shaped so that the electro-optical part 35 of the sensor (i.e. the detector 40 and the circuits 46 located beneath the transmission image sensor plate 42) can be positioned at the original location shown in FIGS. 2 and 3, for instance in a recess provided in the mirror block 11. This means that the length of the connection lines between the optical part 34 arrange in the substrate table 1 and the electro-optical part 35 arranged in the mirror block 11 can be kept relatively short and simple.

Another advantage of embodiments of the invention is that if marks are provided on the substrate table, they can be measured with the alignment system and it becomes easy to diagnose possible slip between mirror block 11 and substrate table 10. If the clamping between mirror block 11 and wafer table 10 is not good enough, the substrate table might slip when the mirror block is moved. If slip occurs while the stage is moving to make the exposures, an overlay offset might be introduced.

Substrate table slip is currently diagnosed by loading a substrate, measure the substrate alignment marks, shaking the substrate stage, and measure the alignment marks again to check for shifts. However, it is then not possible to separate substrate vs. substrate table slip from substrate table vs. mirror block slip. With alignment marks on the substrate table, for instance the earlier-mentioned transmission image sensor grating 41 and/or the ILIAS grating, the two effects (i.e. the substrate-to-substrate table slip and the substrate table-to-mirror block slip) can be measured separately. For instance, when the substrate table 10 is configured to allow the optical part of the transmission image sensor to be positioned at an area of the substrate table that, when in use, is not covered by the substrate, the transmission image sensor may be used to measure the position of the substrate table with respect to the mirror block. From the determined positions a controller, for instance controller 46 shown in FIG. 5, may determine the slip of the substrate table relative to the mirror block.

The distances between sensor grating 41 of the plate 42 and the electro-optical part, for instance the photodetector 40, may also be made larger. In this case a relay optics is arranged in the mirror block 11. The space created by enlarging the distance between the optical part 34 and the electro-optical part 35 may even be used to advantage, for instance by integrating therein a collimating optics.

In other embodiments additionally or alternatively one or more sensors of the “integrated lens interferometers at scanner (ILIAS)” type sensor are used. An ILIAS sensor 47 (cf. FIG. 2) is a wave front sensor that is used to measure lens aberrations per field point. The wave front sensor is based on the principle of shearing interferometry and comprises a source module and a sensor module. The source module has a patterned layer of chromium that is placed in the object plane of the projection system and has additional optics provided above the chromium layer. The combination provides a wave front of radiation to the entire pupil of the projection system. The sensor module has a patterned layer of chromium that is placed in the image plane of the projection system and a camera that is placed some distance behind said layer of chromium. The patterned layer of chromium on the sensor module diffracts radiation into several diffraction orders that interfere with each other giving rise to a interferogram. The interferogram is measured by the camera. The aberrations in the projection lens can be determined by software based upon the measured interferogram. According to embodiments of the present invention the optical elements of the sensor module of the ILIAS sensor 47 are arranged in the substrate table 10 of the substrate stage, while the electro-optical elements of the sensor module are arranged in the mirror block 11. Due to the higher stability of the mounting of the ILIAS sensor in these embodiments, the aberrations may be determined with a very high accuracy.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. In this regard, the data storage medium may be a machine-readable medium having machine-executable instructions for performing the methods described herein.

The descriptions above are intended to be illustrative, not limiting. Thus, it will be apparent to one skilled in the art that modifications may be made to the invention as described without departing from the scope of the claims set out below.

1. A substrate table configured and arranged to hold a substrate in a lithographic exposure apparatus for exposing a substrate to a patterned radiation beam, comprising:
a sensor, an optical part thereof being integrated with the substrate table, the optical part of the sensor further being arranged to receive the patterned radiation beam, to determine properties of the patterned radiation beam depending on relative positions of the optical part and the patterned radiation beam, and to cooperate with a further part of the sensor that is arranged to receive at least a part of the patterned radiation beam via the optical part.

2. A substrate table in accordance with claim 1, wherein the optical part of the sensor is arranged to transmit at least a part of the patterned radiation beam to the further part of the sensor.

3. A sensor for measuring a patterned beam of radiation in a lithographic exposure apparatus, comprising:
a receiving part, constructed and arranged to receive the patterned beam of radiation, and to transmit a maximum fraction of radiation when the receiving part and the patterned beam of radiation have particular corresponding relative positions and a smaller fraction in other relative positions; and
a processing part arranged to receive the transmitted fraction of radiation, wherein the receiving part is integrated in a substrate table that is constructed and arranged to hold a substrate in the lithographic exposure apparatus.

4. A sensor in accordance with claim 3, wherein the processing part comprises an electro-optical part.

5. A sensor in accordance with claim 4, wherein the electro-optical part comprises a radiation detector.

6. A sensor in accordance with claim 3, wherein the receiving part comprises a transmissive plate with a sensor grating and wherein the processing part is arranged to receive radiation transmitted by the sensor grating through the transmissive plate.

7. A sensor in accordance with claim 3, wherein the substrate table further comprises:
a central table portion configured to receive the substrate; and
an outwardly protruding portion configured to accommodate the receiving part of the sensor.

8. A sensor in accordance with claim 3, wherein the substrate table comprises at least one clamping element constructed and arranged to clamp the substrate to the substrate table.

9. A sensor in accordance with claim 3, wherein the sensor is a transmission image sensor or an integrated lens interferometer.

10. A sensor as recited in claim 3, in combination with a substrate stage for a lithographic exposure apparatus, wherein the sensor is further incorporated in the substrate stage and wherein the substrate stage further comprises a support element for supporting the substrate table, the support element comprising the processing part of the sensor.

11. A sensor as recited in claim 10, in combination with a further sensor comprising a respective receiving part constructed and arranged to receive the patterned radiation beam, the further receiving part being integrated with the substrate table.

12. A sensor as recited in claim 10, in combination with a controller configured and arranged to determine a relative slip between the substrate table and the support element.

13. A method of positioning a target portion of a substrate in a patterned beam of radiation, comprising:
positioning the substrate on a substrate table;
determining a position of the target portion by measuring the position of a plurality of alignment marks on the substrate using an alignment sensor;
determining the position of a radiation sensor using the alignment sensor;
measuring the position of the patterned beam of radiation relative to a receiving part of a sensor integrated with the substrate table; and
using the determined position of the target portion, the determined position of the radiation sensor and the determined position of the patterned beam of radiation to position the target portion in the patterned beam of radiation.

14. A method according to claim 13 comprising determining the position of a sensor alignment mark with the alignment sensor and wherein determining the position of the radiation sensor comprises using the determined position of the sensor alignment mark and information on the relative positions of the sensor alignment mark and the receiving part.

15. A method according to claim 13 wherein the receiving part comprises a grating and the position of the patterned beam of radiation is determined by measuring the radiation intensities for a plurality of the relative positions between the patterned beam of radiation and the receiving part, and determining a relative position where the measured radiation intensity is maximal.
